(19) United States
(12) Patent Application Publication
(10) Pub. No.: US 2015/0292397 A1
(43) Pub. Date: Oct. 15, 2015

(54) TURBOCHARGING SYSTEM AND METHOD

(71) Applicant: Arnold Magnetic Technologies, Rochester, NY (US)

(72) Inventor: Larry A. Kubes, Indianapolis, IN (US)

(73) Assignee: Arnold Magnetic Technologies, Rochester, NY (US)

(21) Appl. No.: 14/253,382

(22) Filed: Apr. 15, 2014

(51) Int. Cl. F02B 39/10

(52) U.S. Cl. CPC F02B 39/10

(57) ABSTRACT

A turbocharger system for a combustion engine includes a turbine, a generator, an electric motor, and a compressor. The turbine is disposed in flow communication with an exhaust flow of the combustion engine productive of exhaust gases, the generator is operably connected to the turbine to produce electrical power in response to operation of the turbine, the compressor is disposed in flow communication with an air intake system of the combustion engine, and the electric motor is operably connected to the compressor to cause operation of the compressor in response to operation of the electric motor. The electric motor is operably connected to the generator via electrical wires configured to deliver electrical power from the generator to the electric motor to cause operation of the electric motor absent a mechanical driving shaft connection between the generator and the electric motor.

### BACKGROUND OF THE INVENTION

The present disclosure relates generally to a turbocharging system for an automotive system, more particularly to a turbocharging system employing an eTurbine and an eCompressor, and even more particularly to a turbo charging system that is shaftless between the eTurbine and the eCompressor.

With the increasing need to improve automotive tailpipe exhaust emissions, it is becoming increasingly important to be able to further enhance the efficiency of the combustion cycle. Turbochargers do an exemplary job of increasing the intake air charge pressure, which forces more air into the combustion chamber to increase power output. A benefit of this increase in power output is that a relatively smaller engine can now be used to achieve the same vehicle drivability and performance. Additional benefits result from this engine downsizing in that during idle conditions, such as at stoplights, a smaller engine burns less fuel than a larger engine, but still provides enough power to the vehicle to power accessories such as air conditioning compressors and power steering pumps at idle, while maintaining good vehicle performance.

Engine downsizing with turbocharging is becoming very commonplace in the automotive industry. Current state of the art turbochargers use a turbine mounted in the exhaust stream to capture exhaust flow inertia and heat energy to turn a shaft that is coupled to a compressor which drives more air into the engine combustion chamber.

New trends in automotive turbocharging involve using an electric motor mounted to the turbocharger unit or to the individual components of the turbine and the compressor. These components are known as eTurbos, eTurbine, and eCompressor, respectively. Advanced power electronics have enabled inverters to be manufactured that can drive an electric motor to a highly controllable state, including clockwise and counterclockwise directions, and with very precise speeds and very rapidly changeable speeds from 0 to over 100,000 revolutions per minute (rpm).

While existing eTurbos, eTurbines and eCompressors may be suitable for their intended purpose, the art relating to automotive turbocharging systems would be advanced with a turbocharging system that offers additional opportunities to control and reduce exhaust emissions in, and improve the overall efficiency of, a combustion engine.

This background information is provided to reveal information believed by the applicant to be of possible relevance to the invention. No admission is necessarily intended, nor should be construed, that any of the preceding information constitutes prior art against the invention.

### BRIEF DESCRIPTION OF THE INVENTION

An embodiment of the invention includes a turbocharger system for a combustion engine having a turbine, a generator, an electric motor, and a compressor. The turbine is disposed in flow communication with an exhaust flow of the combustion engine productive of exhaust gases, the generator is operably connected to the turbine to produce electrical power in response to operation of the turbine, the compressor is disposed in flow communication with an air intake system of the combustion engine, and the electric motor is operably connected to the compressor to cause operation of the compressor in response to operation of the electric motor. The electric motor is operably connected to the generator via electrical wires configured to deliver electrical power from the generator to the electric motor to cause operation of the electric motor absent a mechanical driving shaft connection between the generator and the electric motor.

Another embodiment of the invention includes a method of operating a turbocharger system for a combustion engine. In the method, a turbine is operated in response to an exhaust flow from the combustion engine, the turbine being disposed in flow communication with the exhaust flow. In response to operating a turbine, a generator is operated and is productive of an AC voltage. The AC voltage is communicated via electrical wires to an electric motor. The electric motor is operated in response to the AC voltage being received at the electric motor. In response to the operating the electric motor, a compressor is operated to produce an increase in air pressure at an air intake system of the combustion engine.

The above features and advantages and other features and advantages of the invention are readily apparent from the following detailed description of the invention when taken in connection with the accompanying drawings. The above features and advantages and other features and advantages of the invention may also be combined with features and advantages of co-owned application Ser. No. ______ concurrently filed ______ entitled THROTTLE CONTROL SYSTEM AND METHOD and having attorney docket number ADT0005US, which is herein incorporated by reference in its entirety.

### BRIEF DESCRIPTION OF THE DRAWINGS

Referring to the exemplary non-limiting drawings wherein like elements are numbered alike in the accompanying Figures:

FIG. 1 depicts in schematic form an automotive system that includes a compressor having an electric motor that is electrically driven by a generator connected to a turbine, in accordance with an embodiment of the invention;

FIGS. 2 and 3 depict in schematic cross-sectional form electrical machines representative of a motor or a generator, in accordance with an embodiment of the invention; and

FIG. 4 depicts a flow chart of a method, in accordance with an embodiment of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

An embodiment of the invention, as shown and described by the various figures and accompanying text, provides a turbocharger system for a combustion engine that includes a turbine, a generator of electrical power mechanically connected to the turbine, an electric motor, and a compressor mechanically connected to the motor, where the motor is electrically connected to the generator via electrical wires, and where the turbocharger system is absent a direct mechanical drive shaft between the turbine and the compressor.

While the embodiment described and illustrated herein depicts an inline four cylinder configuration as an exemplary combustion engine, it will be appreciated that the disclosed invention is not so limited and is also applicable to other cylinder configurations, such as but not limited to inline two cylinder, v-type two cylinder, inline three cylinder, inline five cylinder, inline six cylinder, v-type six cylinder, inline eight cylinder, v-type eight cylinder, inline ten cylinder, v-type ten cylinder, inline twelve cylinder, v-type twelve cylinder, and rotary engines having any number of combustion chambers, for example.

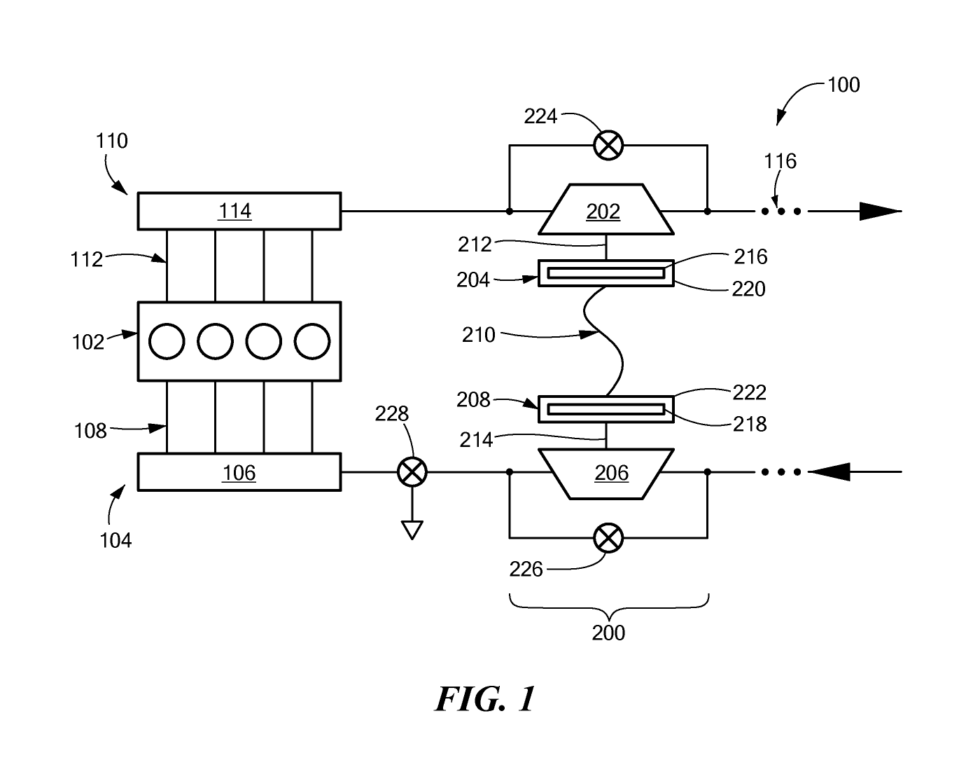

FIG. 1 depicts in block diagram form an automotive system 100 that includes a combustion engine (CE) 102 and a turbocharger system (TCS) 200 for boosting air intake in the CE 102 on demand. Disposed in flow communication with the CE 102 is an air intake system 104 that includes an intake manifold 106 and intake ports 108, and an exhaust output system 110 that includes exhaust ports 112 and an exhaust manifold 114.

A turbine 202 is disposed in flow communication with an exhaust flow from the exhaust manifold 114 of the CE 102, which is productive of exhaust gases that drive the turbine (i.e., turbine blades). Exhaust gases downstream of the turbine 202 pass through an exhaust system (catalytic converter, muffler and tailpipe for example) depicted as ellipses 116 to ambient.

A generator 204 is operably connected to the turbine 202 to produce electrical power in response to operation of the turbine 202. As used herein, it will be understood that the term operation of the turbine 202 means rotation of a turbine wheel within a housing of the turbine 202. A compressor 206 is disposed in flow communication with an intake flow of the air intake system 104 to provide compressed air to the air intake system 104 on demand. An electric motor 208 is operably connected to the compressor 206 to cause operation of the compressor 206 in response to operation of the electric motor 208. As used herein, it will be understood that the term operation of the compressor 206 means rotation of an impeller within a housing of the compressor 206. The electric motor 208 is operably connected to the generator 204 via electrical wires 210 configured to deliver electrical power from the generator 204 to the electric motor 208 to cause operation of the electric motor 208 absent any mechanical driving shaft connection between the generator 204 and the electric motor 208. That is, in an embodiment the electric motor 208 is operably and directly connected to the generator 204 via electrical wires 210. In general, it is the induced voltage from the generator 204 that drives the electric motor 208 via the electrical wires 210. However, it will also be appreciated that first and second inverters (not shown) may be used in the electrical path of the electrical wires 210 to drive the compressor 206, where the first inverter would be disposed and configured to receive induced voltage from the generator 204 and deliver electrical power at a first voltage and frequency to the second inverter, and the second inverter would be disposed and configured to deliver electrical power at a second voltage and frequency, which may be the same as or different from the first voltage and frequency, to the electric motor 208, which in turn drives the compressor 206.

In an embodiment, the generator 204 is disposed in direct mechanical connection with the turbine 202 via a mechanical drive shaft 212 having a one-to-one input-output ratio. In another or the same embodiment, the electric motor 208 is disposed in direct mechanical connection with the compressor 206 via a mechanical drive shaft 214 having a one-to-one input-output ratio.

In an embodiment, the electric motor 208 and the compressor 206 are both configured to be rotatable in both clockwise and counterclockwise directions, thereby enabling the compressor 206 to deliver increased air pressure or decreased air pressure to the air intake system 104 depending on the direction of rotation and speed of the compressor 206.

In an embodiment, at least one of the generator 204 and the electric motor 208 have a permanent magnet rotor 216, 218, respectively. And in another embodiment, both the generator 204 and the electric motor 208 each have an electrically wired stator 220, 222 and a permanent magnet rotor 216, 218, respectively. In an embodiment, the generator 204, instead of having a permanent magnet rotor 216, may have some other form of self-excited rotor, such as a self-excited rotor having a center winding and slip ring that creates a magnetic field from the slip ring, for example. Additionally, it will also be appreciated that the electric motor 204 may be an asynchronous or a synchronous motor, such as an AC induction motor or a switched reluctance motor, respectively, as opposed to a (synchronous) permanent magnet motor.

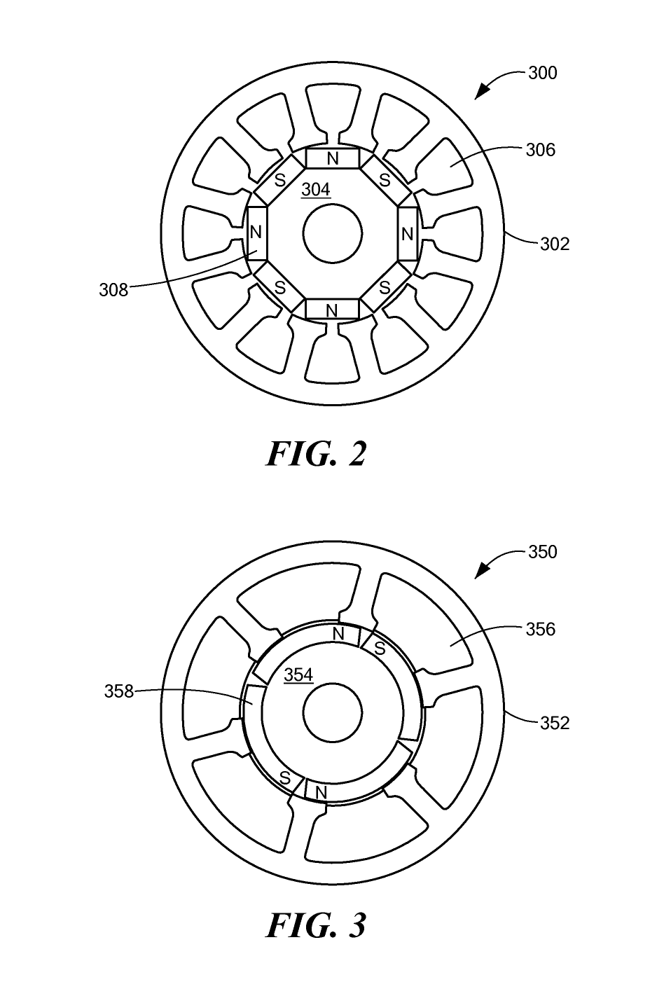

Reference is now made to FIGS. 2 and 3, which depict in schematic, cross-sectional form electrical machines 300, 350 that are representative of an electrical generator, such as generator 204 for example, or an electric motor, such as motor 208 for example. Each machine 300, 350 has a stator 302, 352 (synonymous with stators 220, 222 for example) and a permanent magnet rotor 304, 354 (synonymous with rotors 216, 218 for example). Electrical machine 300 is depicted having twelve winding slots 306 in the stator 302 for receiving electrical windings (not illustrated but well known in the art), and eight magnetic poles 308, four north poles and four south poles, on the rotor 304. Electrical machine 350 is depicted having six winding slots 356 in the stator 352 for receiving electrical windings (not illustrated but well known in the art), and four magnetic poles 358, two north poles and two south poles, on the rotor 354. While FIGS. 2 and 3 each depict electrical machines 300, 350 having a certain number of slots and poles, it will be appreciated that these certain numbers are for illustration purposes only and are not intended to limit the scope of the invention. For example, and for a given electrical machine, the number of poles and slots may be different from the number illustrated in FIGS. 2 and 3, the number of poles may be less than, equal to, or greater than the number of corresponding slots, and the number of poles and slots on one electrical machine 300 may be equal to or different from the respective number of poles and slots on the other electrical machine 350. While the foregoing discussion describes example electrical machines 300, 350 having a permanent magnet rotor 304, 354, it will be appreciated that such an arrangement is exemplary only and is not intended to limit the scope of the invention, as other types of electrical machines may be equally suitable for a purpose disclosed herein, such as an AC induction motor, a switched reluctance motor, a synchronous motor, or an asynchronous motor, for example. The use of any electrical machine suitable for a purpose disclosed herein is considered to be within the scope of the invention.

Accordingly, it will be appreciated that an embodiment includes an arrangement where the generator 204 has a first number of magnetic poles on the rotor 216 and a first number of wiring slots on the stator 220, the electric motor 208 has a second number of magnetic poles on the rotor 218 and a second number of wiring slots on the stator 222, and at least one of the first number of poles and the first number of slots are different from at least one of the second number of poles and the second number of slots. By varying the number of pole and slot arrangements between the turbine 202 and compressor 206, the rotational speeds of the turbine 202 and compressor 206 may be ratio'd to provide a gearing-type drive arrangement between the turbine 202 and compressor 206.

Since the output voltage and frequency of the electrical power from the generator 204 is determined by the rotational speed of the generator 204 driven by the turbine 202, the rotational speed of the compressor 206 driven by the motor 208 will be proportional to the rotational speed and frequency of the generator 204 by a ratio of the internal design aspects, namely the number of poles and slots discussed above, of the respective generator 204 and motor 208. In general, the voltage magnitude and frequency input to the electric motor 208 is proportional to the voltage magnitude and frequency output, respectively, from the generator 204. As the rotational speed of the turbine 202 increases, the rotational speed of the generator 204 increases, the rotational speed of the motor 208 increases, and the rotational speed of the compressor 206 increases. If the number of poles and slots of the generator 204 and motor 208 are the same, the turbine 202 and compressor 206 will operate at equal rotational speeds. However, an embodiment also encompasses an arrangement of poles and slots such that a rotational speed of operation of the compressor 206 is in other than a one-to-one ratio with a rotational speed of operation of the turbine 202.

With reference now back to FIG. 1, an embodiment includes an arrangement where one of several valves may be used to control an overspeed or surge speed condition of either the turbine 202 or the compressor 206, or both. As depicted in FIG. 1, a wastegate valve 224 is disposed in flow communication with the turbine 202 in such a manner as to divert at least a portion of the exhaust flow from the exhaust manifold 114 to bypass the turbine 202 in response to a speed of the turbine 202 reaching or exceeding a defined level, or the turbine being driven to operate in a surge range. Pressure to operate the wastegate valve 224 may be obtained from the outlet side of the compressor 206. As this pressure increases to a defined level, the pressure overcomes a spring force in a diaphragm of an actuator, which causes the actuator to open the wastegate valve 224, which causes the exhaust flow to bypass the turbine 202, resulting in less flow through the turbine 202, which causes the turbine 202, and hence the compressor 206, to slow down or maintain a set speed. FIG. 1 also depicts a second wastegate valve 226 disposed in flow communication with the compressor 206 in such a manner as to divert at least a portion of an intake air flow to bypass the compressor 206 in response to a speed of the compressor 206 reaching or exceeding a defined level. In an embodiment, operation of the wastegate valve 226 is similar to that of wastegate valve 224. FIG. 1 further depicts a third type of valve referred to as a blow-off valve 228 disposed downstream of and in flow communication with the compressor 206. In an embodiment, the blow-off valve 228 has a set point that allows excess pressure from overboosting by the compressor 206 to be vented away from the intake manifold 106 and CE 102.

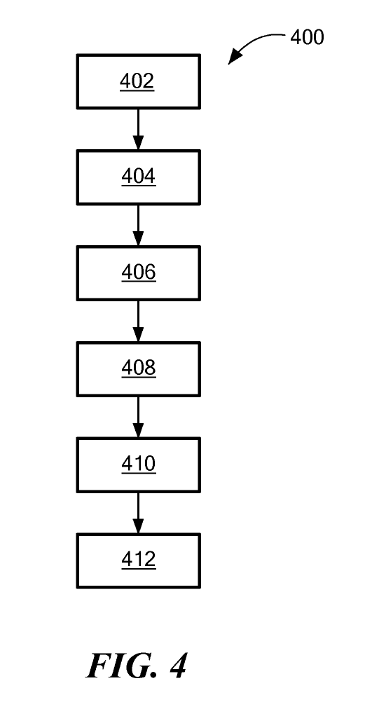

In view of the foregoing, and with reference now to FIG. 4 in combination with FIGS. 1-3, it will be appreciated that a scope of the invention also includes a method 400 of operating the TCS 200 of a CE 102 according to the following.

At block 402, turbine 202 is operated in response to an exhaust flow from the CE 102, where the turbine 202 is disposed in flow communication with the exhaust flow.

At block 404 and in response to the turbine 202 being operated, generator 204 productive of an AC voltage is operated.

At block 406, the AC voltage is communicated via electrical wires 210 to electric motor 208.

At block 408, the electric motor 208 is operated in response to the AC voltage being received at the electric motor 208.

At block 410 and in response to the electric motor 208 being operated, compressor 206 is operated and an increase in air pressure is produced at the air intake system 104 of the CE 102.

In an embodiment, the method 400 at block 404 for operating the generator 204 includes operating the generator 204 at a same rotational speed as the turbine 202 via a mechanical drive shaft 212 having a one-to-one input-output ratio, and the method 400 at block 410 for operating the compressor 206 includes operating the compressor 206 at a same rotational speed as the electric motor 208 via a mechanical drive shaft 214 having a one-to-one input-out ratio.

In an embodiment, the method 400 at block 404 for operating the generator 204 includes operating a permanent magnet rotor 216 of the generator 204.

In an embodiment, the method 400 at block 404 for operating the generator 204 includes operating the generator at a first rotational speed, and the method 400 at block 408 for operating the electric motor 208 includes operating the electric motor 208 at a second rotational speed different from the first rotational speed.

In an embodiment, the method 400 at block 412 further includes facilitating operating of a valve 224, 226, 228 disposed to: bypass exhaust flow around the turbine 202; bypass intake air flow around the compressor 206; or, divert intake air flow exiting the compressor 206 before it enters the air intake system 104.

Some benefits of using the TCS 200 as herein described may include one or more of the following: the ability to package the turbine/generator and compressor/motor in closer proximity to other operational components that they interface with to maximize efficiency and minimize lag in the TCS, resulting in greater performance and/or improved emissions; and, the ability to optimize compressor and turbine configurations through the ability to ratio the speed of operation between the components due to the ability to used generators/motors with differing ratios of poles and slots.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A turbocharger system for a combustion engine, the system comprising:
a turbine disposed in flow communication with an exhaust flow of the combustion engine productive of exhaust gases;
a generator operably connected to the turbine to produce electrical power in response to operation of the turbine;
a compressor disposed in flow communication with an air intake system of the combustion engine;
an electric motor operably connected to the compressor to cause operation of the compressor in response to operation of the electric motor; and
wherein the electric motor is operably connected to the generator via electrical wires configured to deliver electrical power from the generator to the electric motor to cause operation of the electric motor absent a mechanical driving shaft connection between the generator and the electric motor.

2. The system of claim 1, wherein:
the generator is disposed in direct mechanical connection with the turbine via a mechanical drive shaft having a one-to-one input-output ratio.

3. The system of claim 1, wherein:
the electric motor is disposed in direct mechanical connection with the compressor via a mechanical drive shaft having a one-to-one input-output ratio.

4. The system of claim 1, wherein:
the electric motor and the compressor are both configured to be rotatable in both clockwise and counterclockwise directions.

5. The system of claim 1, wherein:
at least one of the generator and the electric motor comprises a permanent magnet rotor.

6. The system of claim 5, wherein:
both the generator and the electric motor each comprise a stator and a permanent magnet rotor.

7. The system of claim 6, wherein:
the generator has a first number of magnetic poles on the rotor and a first number of wiring slots on the stator;
the electric motor has a second number of magnetic poles on the rotor and a second number of wiring slots on the stator; and
at least one of the first number of poles and the first number of slots are different from at least one of the second number of poles and the second number of slots.

8. The system of claim 1, wherein:
a voltage magnitude and frequency input to the electric motor is proportional to a voltage magnitude and frequency output, respectively, from the generator.

9. The system of claim 8, wherein:
the turbine, the generator, the electric motor, and the compressor are each configured such that as a rotational speed of the turbine increases, a rotational speed of the generator increases, a rotational speed of the electric motor increases, and a rotational speed of the compressor increases.

10. The system of claim 1, wherein:
a rotational speed of the compressor is equal to a rotational speed of the turbine.

11. The system of claim 1, wherein:
a rotational speed of the compressor is different from a rotational speed of the turbine, thereby providing a gearing-type arrangement between the turbine and the compressor.

12. The system of claim 1, wherein:
a speed of operation of the compressor is in other than a one-to-one ratio with a speed of operation of the turbine.

13. The system of claim 1, further comprising:
a wastegate valve disposed in flow communication with the turbine in such a manner as to divert at least a portion of the exhaust flow to bypass the turbine in response to a speed of the turbine reaching or exceeding a defined level.

14. The system of claim 1, further comprising:
a wastegate valve disposed in flow communication with the compressor in such a manner as to divert at least a portion of an intake air flow to bypass the compressor in response to a speed of the compressor reaching or exceeding a defined level.

15. The system of claim 1, wherein:
the electric motor is directly connected to the generator via the electrical wires.

16. A method of operating a turbocharger system for a combustion engine, the method comprising:
operating a turbine in response to an exhaust flow from the combustion engine, the turbine being disposed in flow communication with the exhaust flow;
in response to the operating a turbine, operating a generator productive of an AC voltage;
communicating the AC voltage via electrical wires to an electric motor;
operating the electric motor in response to the AC voltage being received at the electric motor;
in response to the operating the electric motor, operating a compressor and producing an increase in air pressure at an air intake system of the combustion engine.

17. The method of claim 16, wherein:
the operating a generator comprises operating the generator at a same rotational speed as the turbine via a mechanical drive shaft having a one-to-one input-output ratio; and
the operating a compressor comprises operating the compressor at a same rotational speed as the electric motor via a mechanical drive shaft having a one-to-one input-out ratio.

18. The method of claim 16, wherein:
the operating a generator comprises operating a permanent magnet rotor of the generator.

19. The method of claim 16, wherein:
the operating a generator comprises operating the generator at a first rotational speed; and
the operating the electric motor comprises operating the electric motor at a second rotational speed different from the first rotational speed.

20. The method of claim 16, further comprising:
facilitating operating of a valve disposed to: bypass exhaust flow around the turbine; bypass intake air flow around the compressor; or, divert intake air flow exiting the compressor before it enters the air intake system.
